(19) United States
(12) Patent Application Publication
(10) Pub. No.: US 2009/0094292 A1
(43) Pub. Date: Apr. 9, 2009

(54) Quality Assurance Tool Kit and Method

(76) Inventor: Lynn Hagan, Brooks, KY (US)

Correspondence Address: MIDDLETON & REUTLINGER, 2500 BROWN & WILLIAMSON TOWER, LOUISVILLE, KY, 40202, US

(21) Appl. No.: 12/247,587

(22) Filed: Oct. 8, 2008

Related U.S. Application Data
(60) Provisional application No. 60/978,212, filed on Oct. 8, 2007.

(51) Int. Cl. G06F 17/30

(52) U.S. Cl. 707/201; 707/E17.005

(57) ABSTRACT

A quality assurance system is provided to collect and store data of quality characteristics of a painted surface. These characteristics may be the date and time of the data collection, ambient temperature, lowest substrate temperature, dew point, humidity, abrasive blasting, preservation, anti-fouling, conductivity, dry film thickness, wet film thickness, preservation minor deficiencies, and sound damping deficiencies. The system is provided with a computer having a user interface capability and read and write capabilities for the data. The system is also provided with a variety of clearance levels for the users of the system that pertain to the read and write capabilities. A method of quality assurance is also provided. The method involves providing a computer system with a user interface and collecting data of quality characteristics of a painted surface.

### CROSS-REFERENCE TO RELATED DOCUMENTS

This application claims priority to and benefit under 35 U.S.C. § 119(e) to U.S. Provisional App. No. 60/978,212, filed on Oct. 8, 2007, the entire contents of which are herein incorporated by reference.

### TECHNICAL FIELD

A surface treatment quality assurance tool and method.

### BACKGROUND

Ocean environments present unique and harsh conditions. Accordingly, ships that travel the oceans must be able to withstand these conditions. For instance, the building material of ocean-going vessels must be able to withstand humid, salty environments. To accomplish this, many rust prone portions of vessels are given a protective coating during the ship-building process and again at staged maintenance intervals.

### SUMMARY

A quality assurance system is provided to collect and store data of quality characteristics of a painted surface. These characteristics may be the date and time of the data collection, ambient temperature, lowest substrate temperature, dew point, humidity, abrasive blasting, preservation, anti-fouling, conductivity, dry film thickness, wet film thickness, preservation minor deficiencies, and sound damping deficiencies. The system is provided with a computer having a user interface capability and read and write capabilities for the data. The system is also provided with a variety of clearance levels for the users of the system that pertain to the read and write capabilities. A method of quality assurance is also provided. The method involves providing a computer system with a user interface and collecting data of quality characteristics of a painted surface.

A particular embodiment of the present invention provides a method of quality assurance. The method has the steps of providing a data acquisition device; providing a data aggregator; providing a database server for a central database; and providing a report generator; synchronizing data from the data acquisition device to the data aggregator; aggregating data collected by said data acquisition device at said data aggregator; storing the aggregated data at the database server and central database; and generating a report at the report generator. The report generator and the database server are connected via a network connection. The data acquisition device is adapted to collect and store a plurality of quality characteristics of a painted surface. Also, the data acquisition device prompts a user for identification credentials.

Another particular embodiment of the present invention provides a tool kit for quality assurance. The tool kit has a data acquisition device; a data aggregator; a database server for a central database; and a report generator. The data acquisition device is adapted to prompt a user for identification credentials. The data acquisition device and data aggregator are adapted to synchronize data between one another. The data aggregator is adapted to aggregate data collected by the data acquisition device. The database server and central database are adapted to store the aggregated data. The report generator is adapted to generate a report. The report generator and the database server are connected via a network connection. The data acquisition device is adapted to collect and store a plurality of quality characteristics of a painted surface.

### BRIEF DESCRIPTION OF THE ILLUSTRATIONS

Embodiments of the invention are illustrated in the following illustrations.

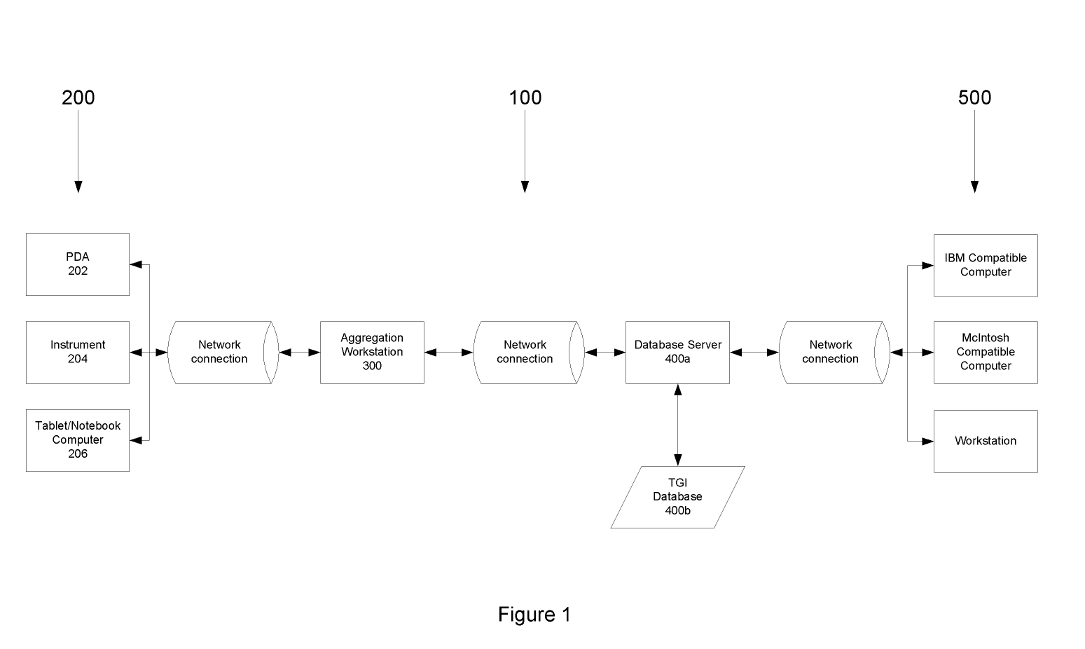

FIG. 1 is a schematic diagram of a hardware architecture of an embodiment of a surface treatment quality assurance tool kit.

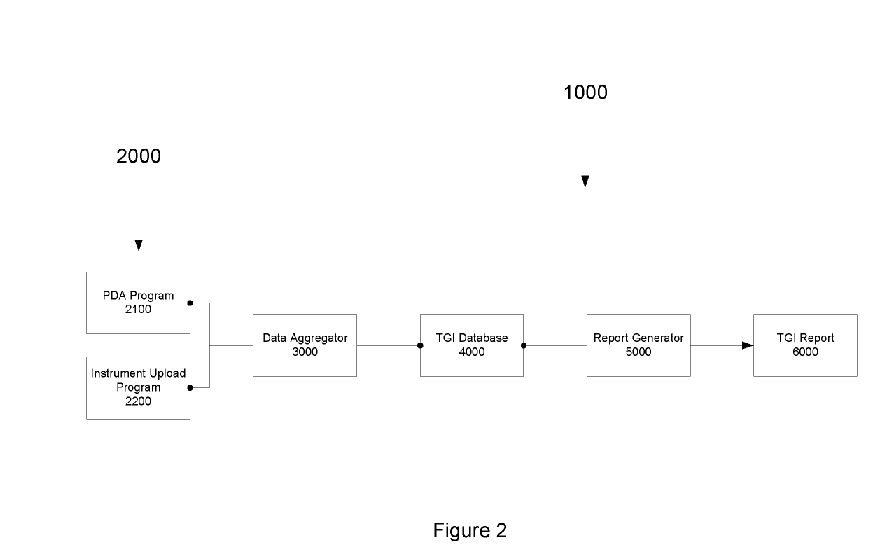

FIG. 2 is a schematic diagram of software architecture of an embodiment of a surface treatment quality assurance tool kit.

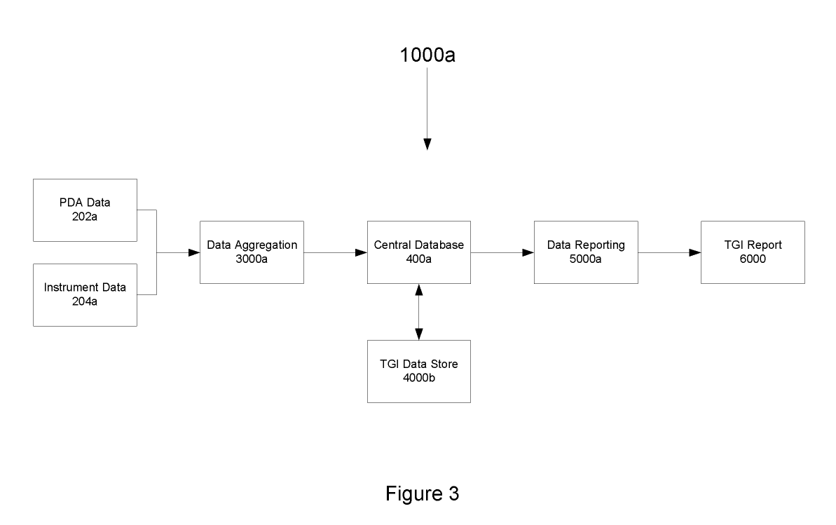

FIG. 3 is a schematic diagram of the data flow of an embodiment of a surface treatment quality assurance tool kit.

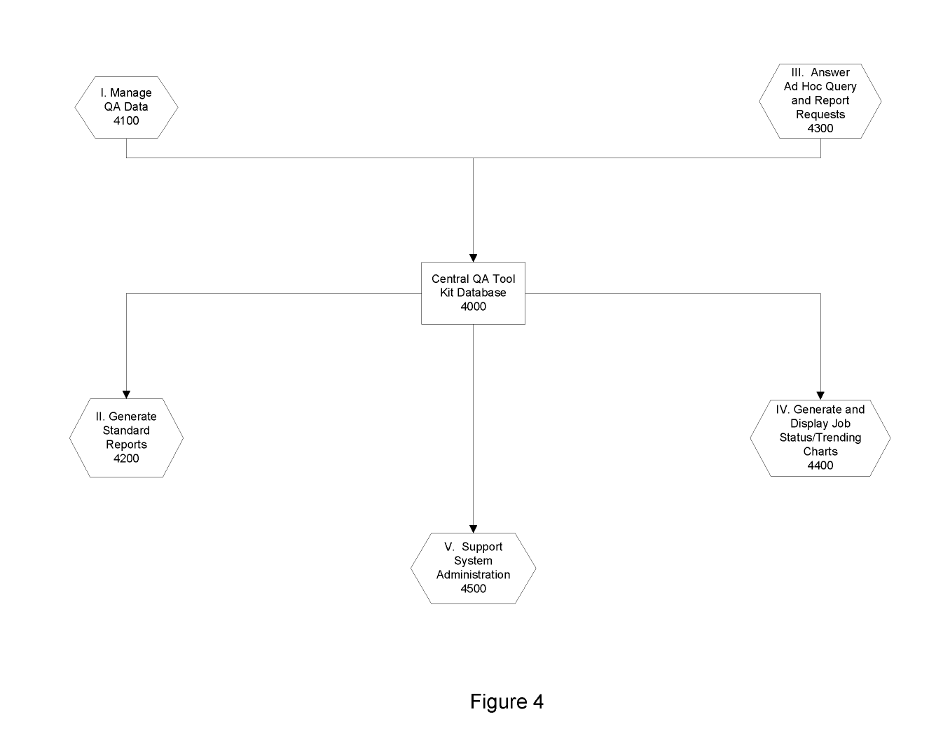

FIG. 4 is a schematic diagram of the database functions.

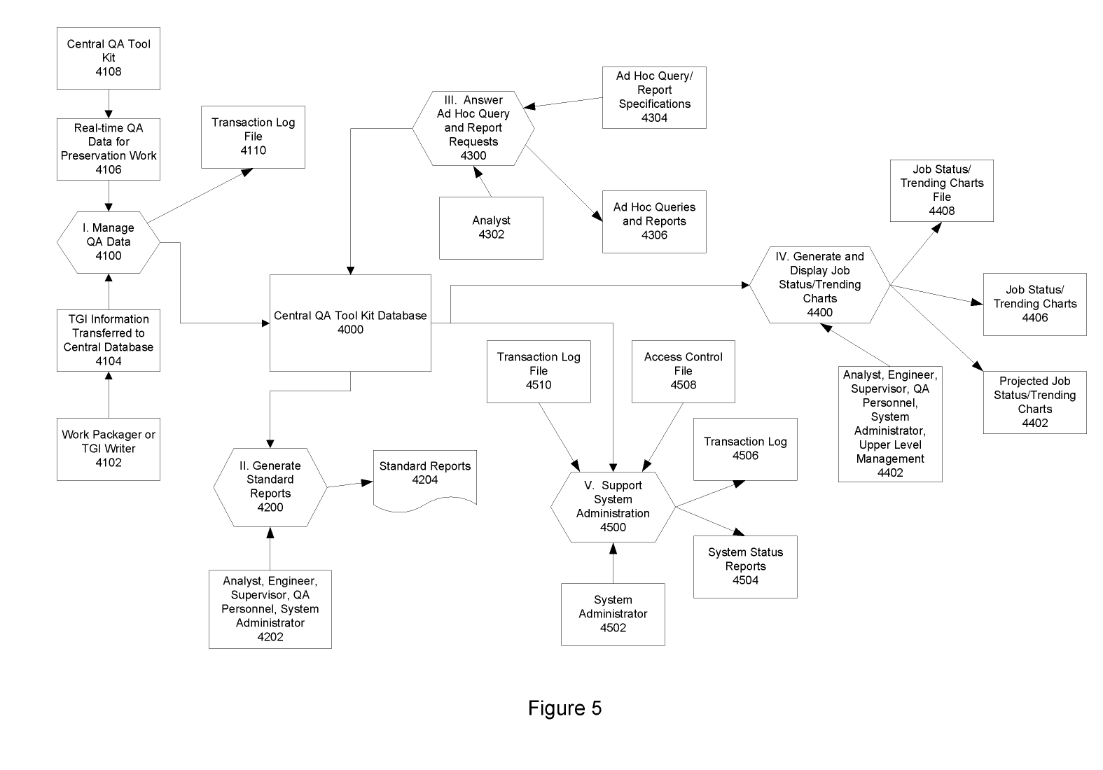

FIG. 5 is the diagram of FIG. 4 with greater detail.

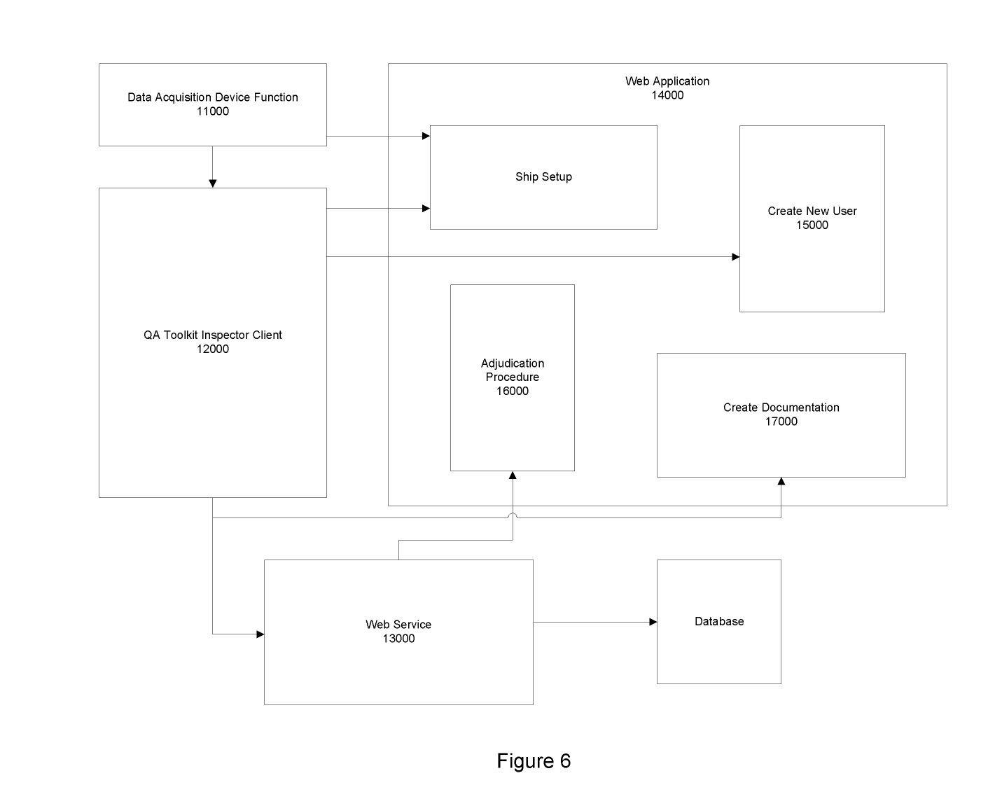

FIG. 6 is a layout of software functions.

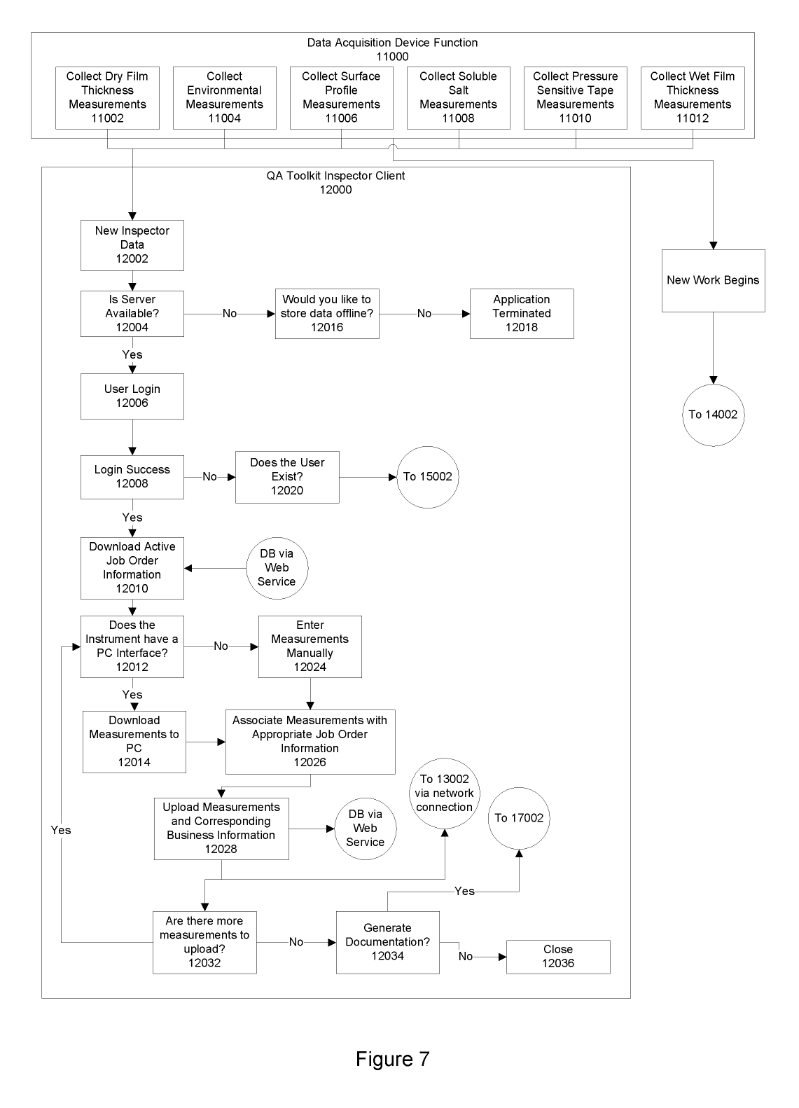

FIG. 7 is a detailed schematic of the data acquisition device function and QA toolkit inspector client of FIG. 6.

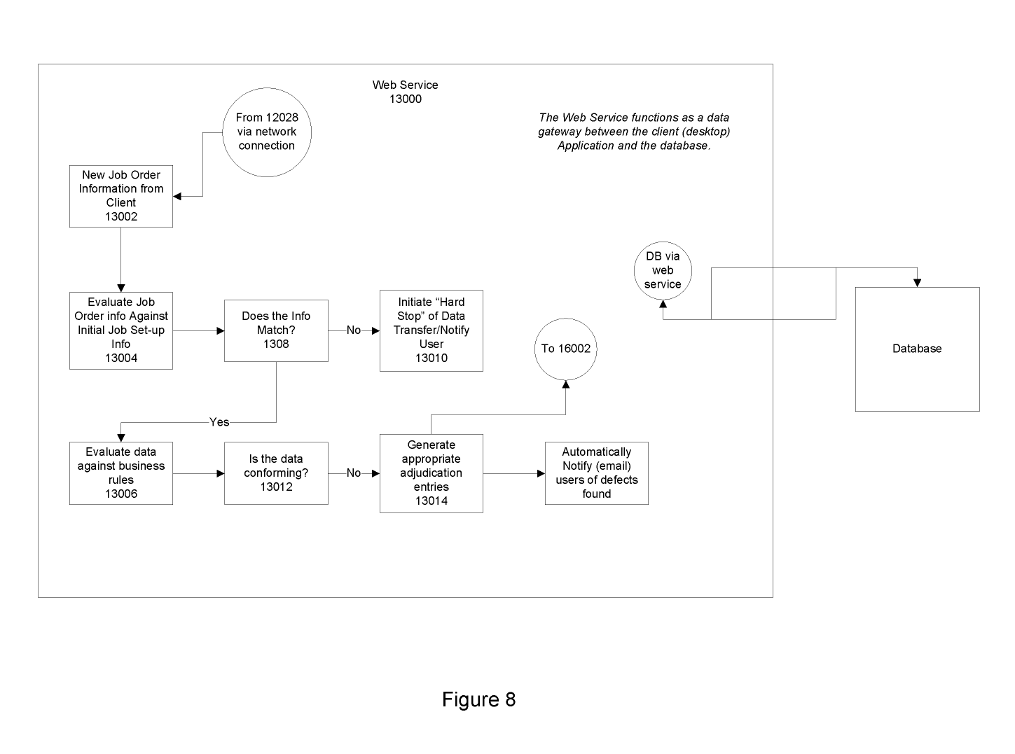

FIG. 8 is a detailed schematic of the web service of FIG. 6.

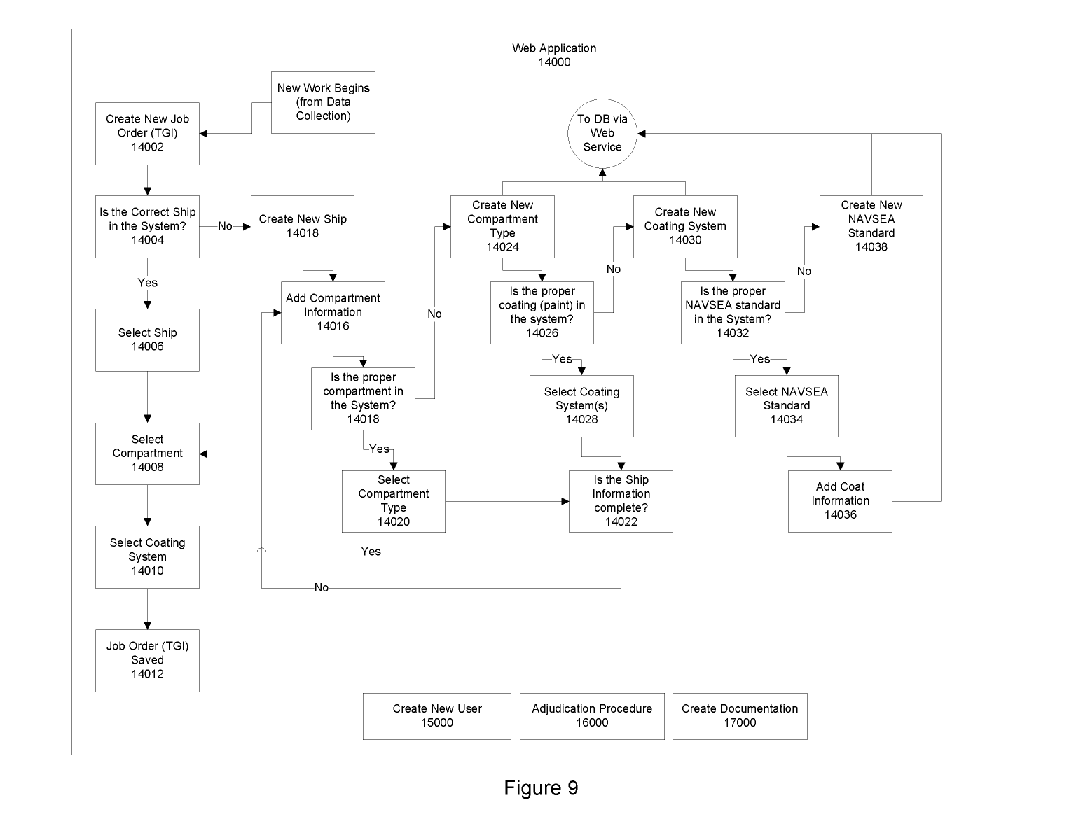

FIG. 9 is a detailed schematic of the web application of FIG. 6.

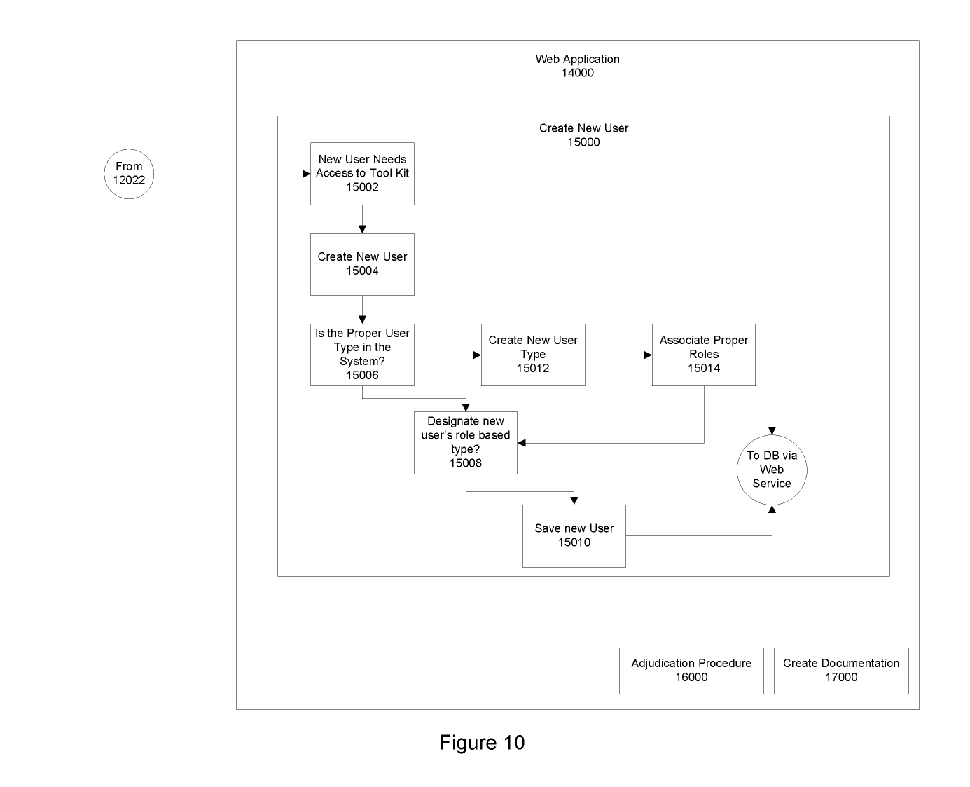

FIG. 10 is a detailed schematic of the web application of FIG. 6.

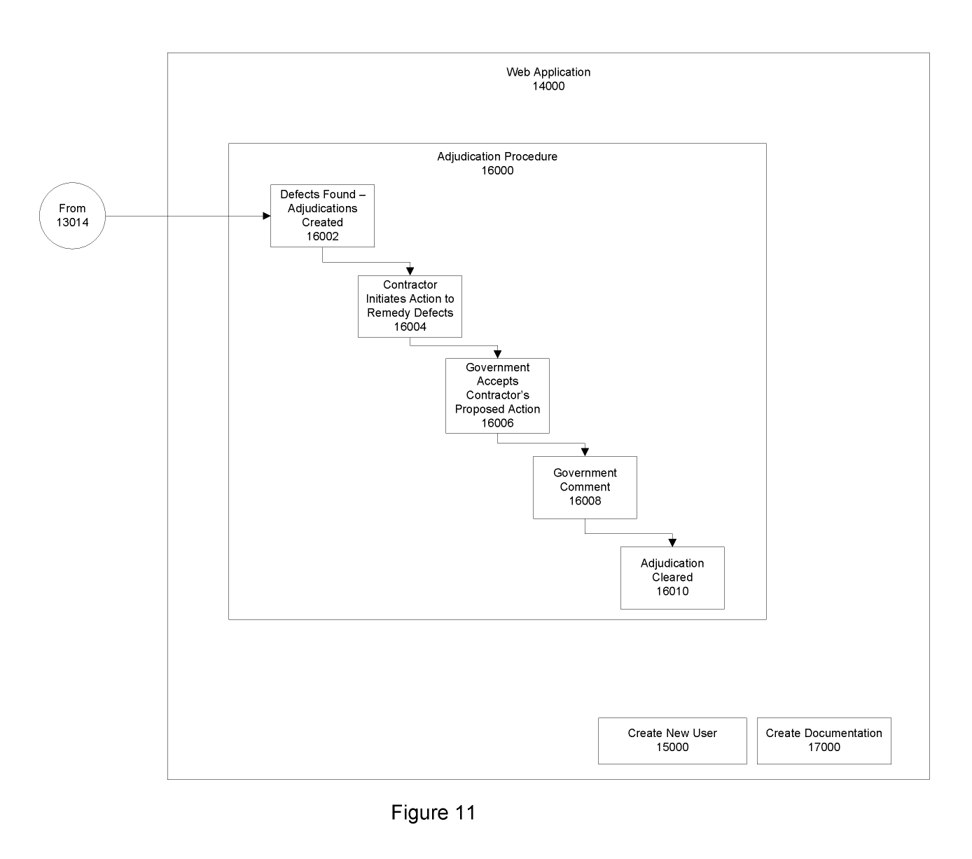

FIG. 11 is a detailed schematic of the web application of FIG. 6.

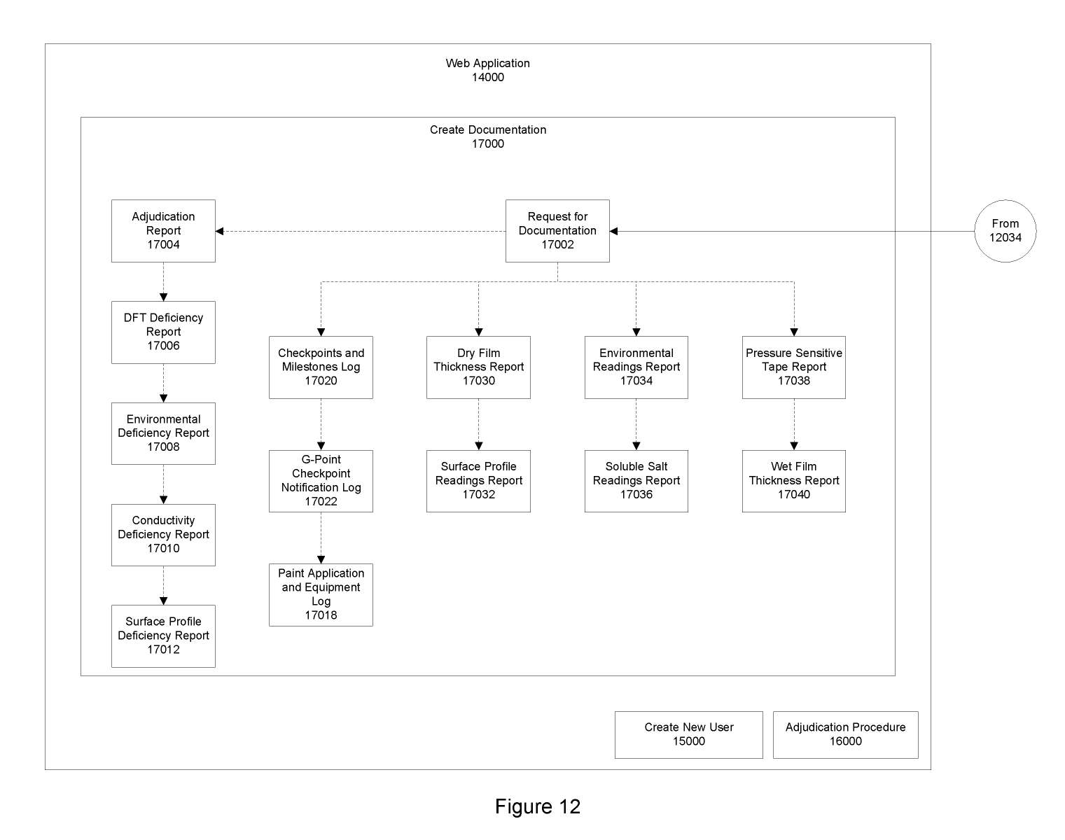

FIG. 12 is a detailed schematic of the web application of FIG. 6.

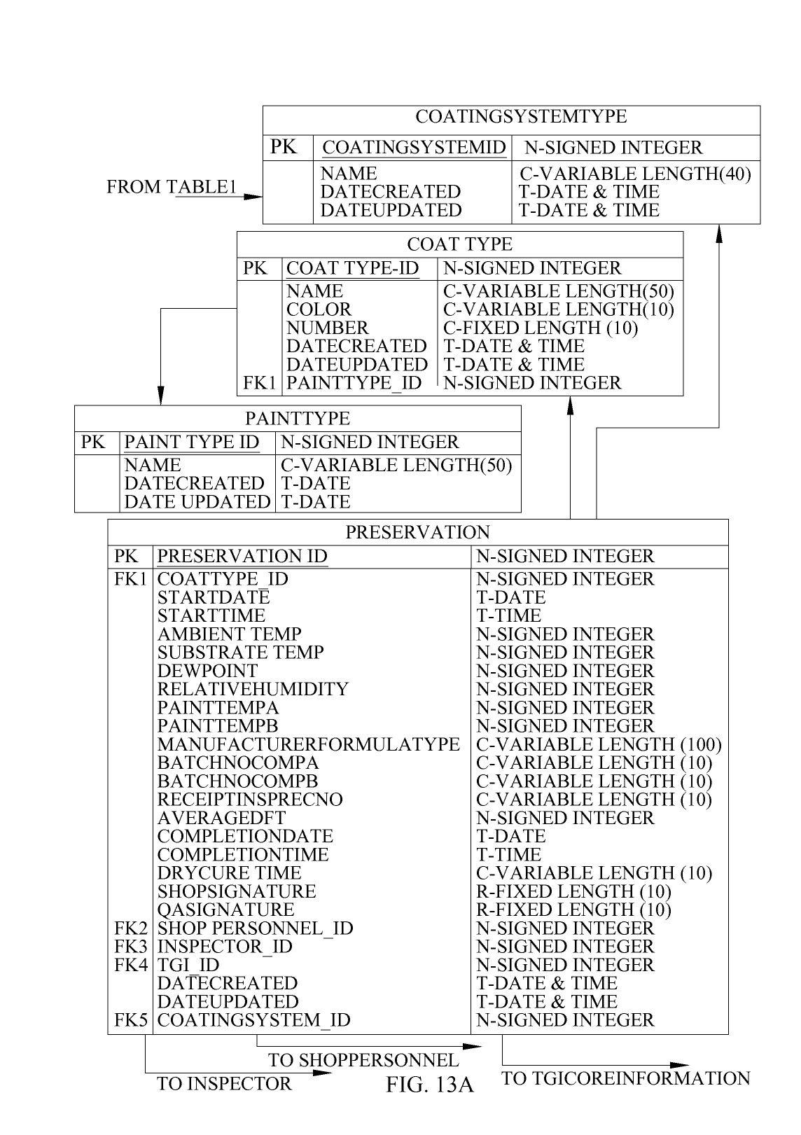

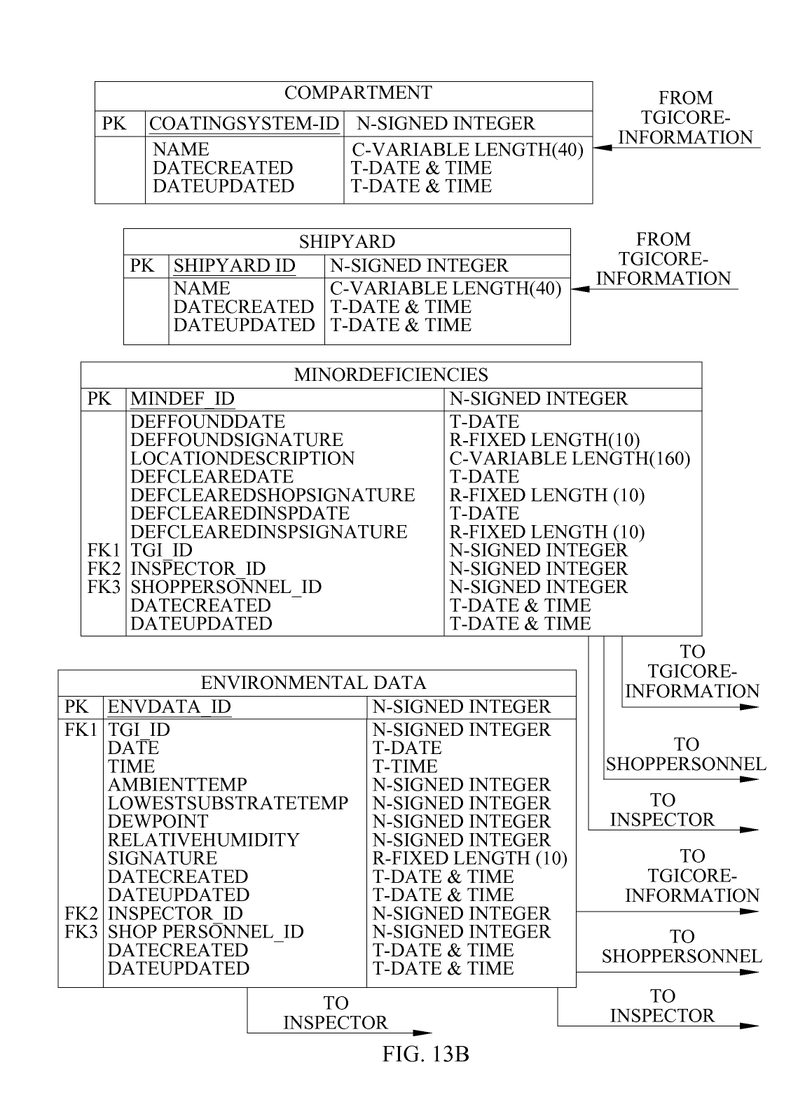

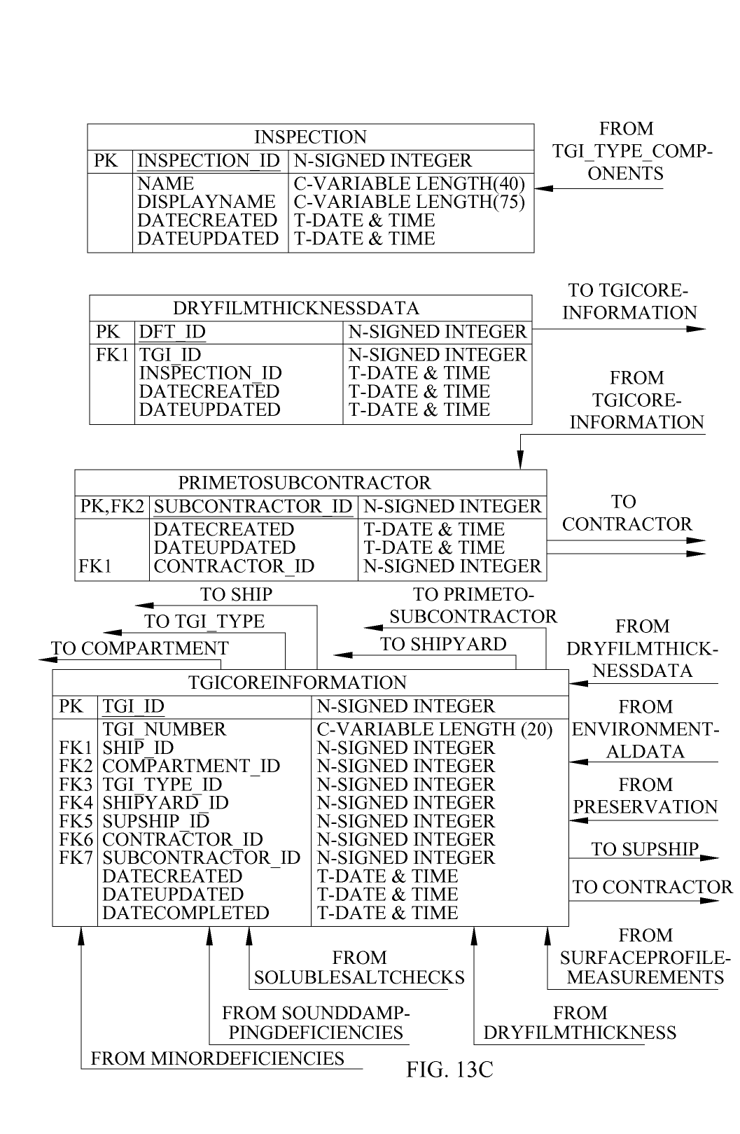

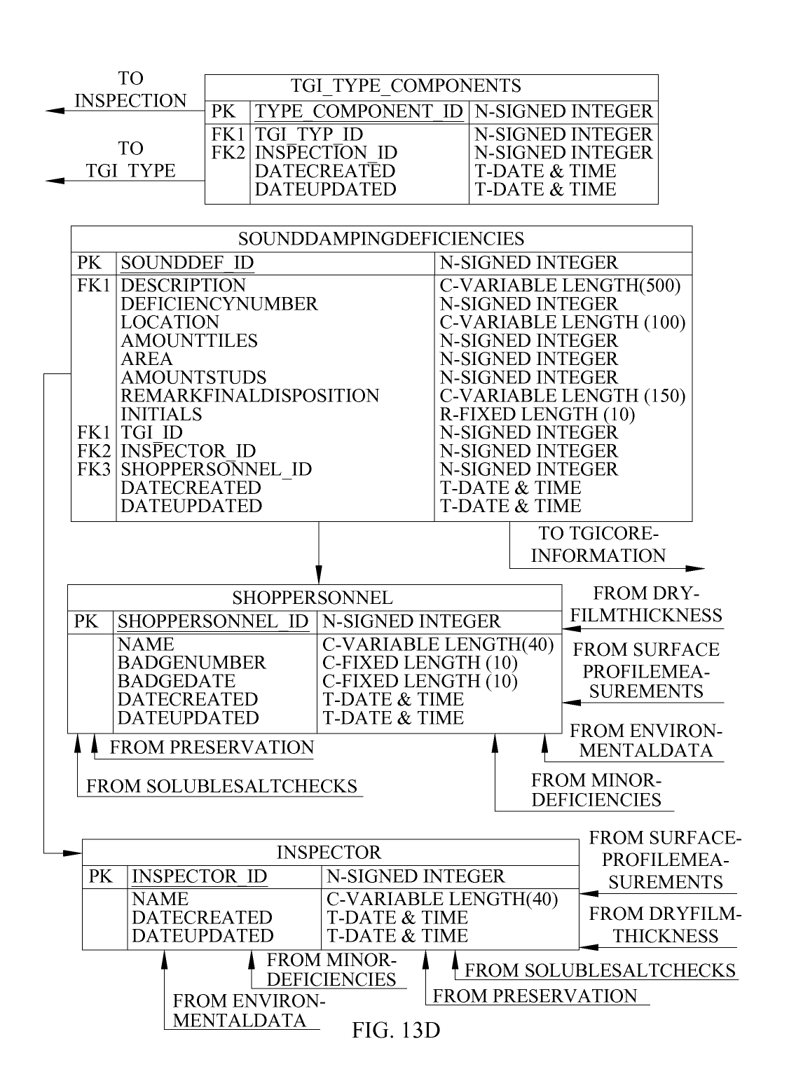

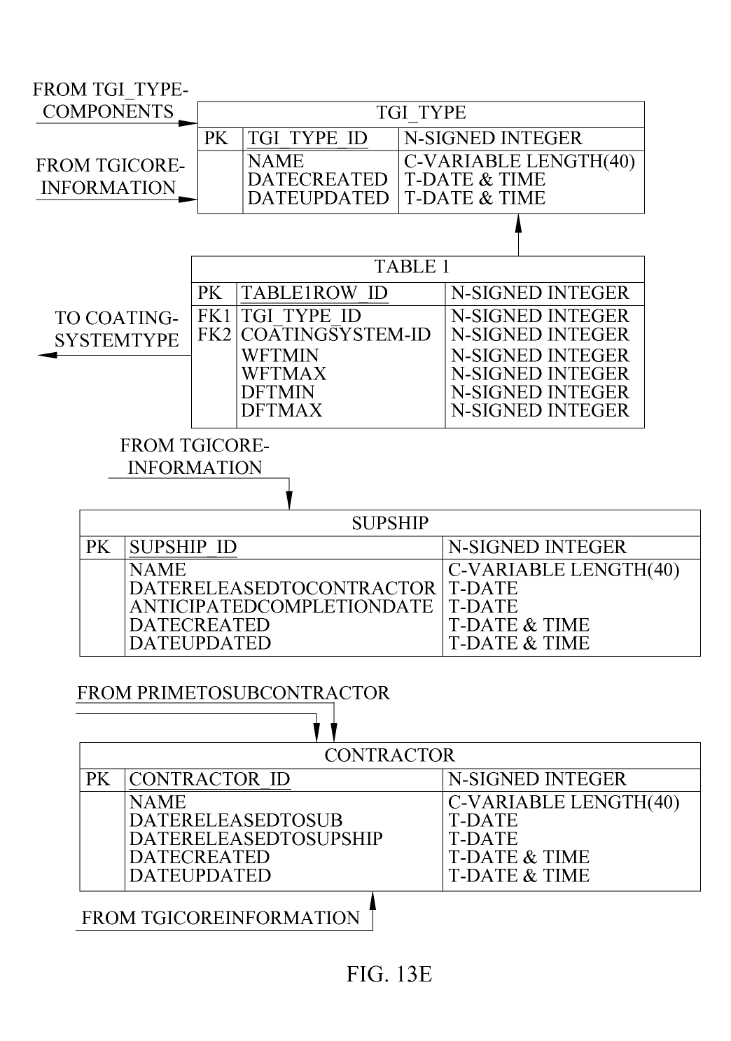

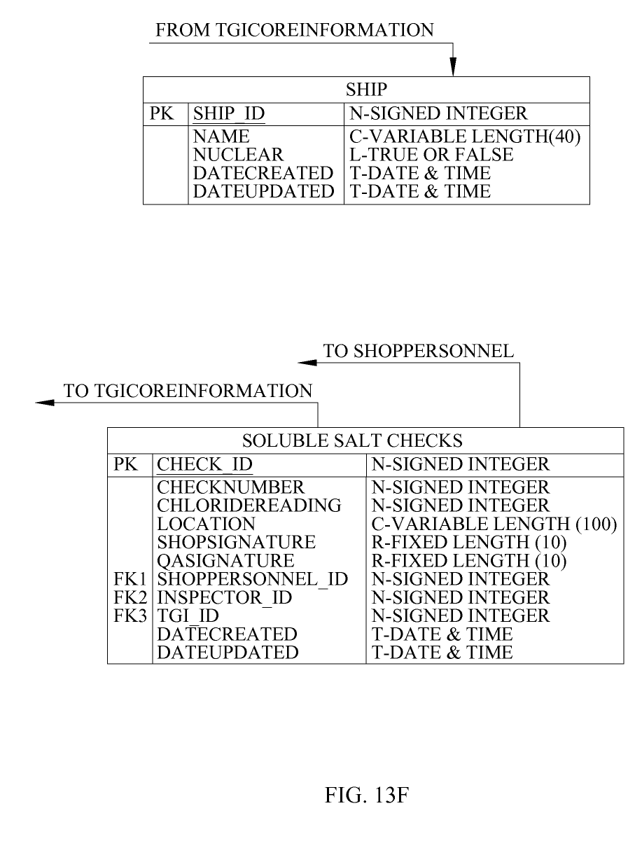

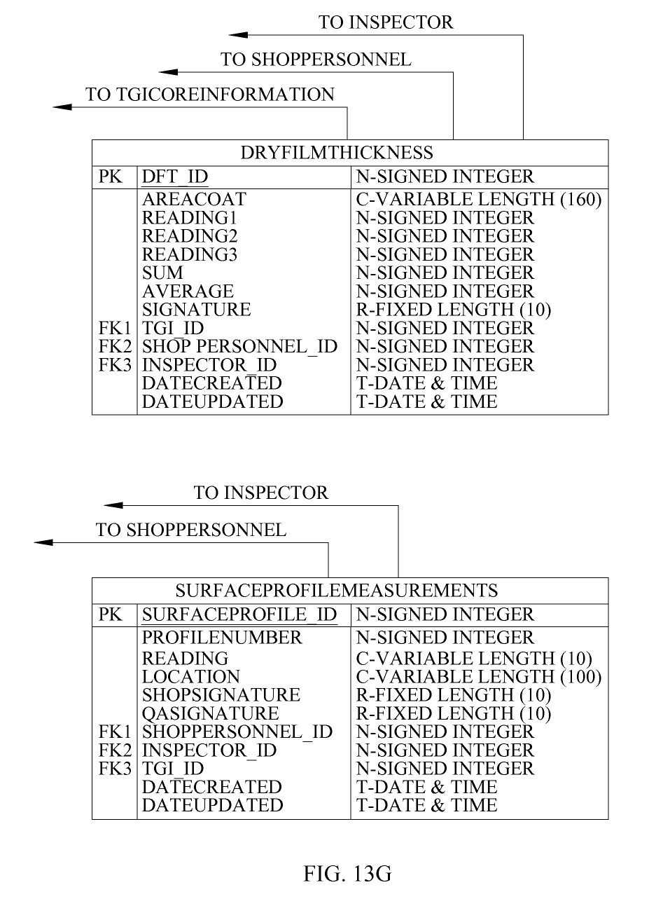

FIG. 13 is an entity relationship diagram of a database of the present invention.

### DETAILED DESCRIPTION

Referring now to FIG. 1, an embodiment of a surface treatment quality assurance system 100 is provided. The tool kit hardware 100 may comprise a data acquisition device 200, a data aggregation element 300, a central database server 400 with a job order or task group instruction (“TGI”) data store 400a, a data reporting element 500.

Referring now to FIGS. 2 and 3, the tool kit software 1000 is provided with a data acquisition device program 2100 and a data acquisition device upload program 2200, a data aggregator 3000, a TGI database 4000, a report TGI generator 5000 and a TGI report 6000. The system may be Microsoft Windows based.

The tool kit data flow 1000a may be provided as follows. Data 2000a from a data acquisition device 200 is transferred to and aggregated at the data aggregation work station 300. This data 3000a is then transferred to the central TGI database 4000 where there is free communication between the central database 4000a and the TGI data store 4000b. This data 4000a, 4000b is transferred to the data reporting step 5000a and on to the TGI Report 6000.

Referring back to FIG. 1, the data acquisition device 200 may be a laptop or tablet computer 202, personal digital assistant (PDA) or pocket PCs 204, or specialty measuring equipment 206. Such a specialty measuring equipment may be a device such as the Elcometer 456 coating thickness gauge that is manufactured by Elcometer, Inc. of Rochester Hills, Mich. The data aggregation element 300 and the data reporting element 600 may be a computer work station, such as, for example, a desktop or laptop computer. Either of these elements 300, 500 may be any number of IBM or McIntosh compatible computer platforms. The central database 400 that stores the TGI data store 500 may be any of a number of database servers, such as, for example, a blade server.

Connections between any of the aforementioned elements may comprise a wide area network, such as the internet, a local area network, any other computer network, a direct connection, or any combination thereof Such networks may be wired, wireless, or a combination of wired and wireless technology. The connections may also comprise encryption technology for secured communications.

The surfaces being treated and subsequently measured may be in confined areas and possibly exposed to the elements. In addition because users of these devices may be hindered by safety equipment, the device 200 may be fumbled and subjected to drops on hard surfaces. Due to these harsh conditions, the data acquisition device 200 may be “ruggedized” to withstand such harsh conditions but should also be considered dispensable.

The device 200 may further comprise a back lit display. Potential values of measurements may be synchronized with the database 400. The user may be able to select these values from a drop-down type menu or push values up and down. The device may also incorporate large buttons to accommodate gloved hands.

Before the data acquisition device 200 may be used, it may prompt the user for identification credentials. Users may uniquely identify themselves in order to successfully interface with each component of the software. This unique identification may be attached to each data record entered. Such identification may be a user's Department of Defense (DoD) issued Certified Access Card (CAC). Accordingly, security for this software may conform to the DoD Information Technology Security Certification and Accreditation Process (DITSCAP) standard. Thus, the DoD training CD for DITSCAP may be provided to all users of this system. Further, the identification may distinguish a user's access level. Such levels may be, for instance, technicians, supervisors, or other levels of management. These levels may further determine the functions that a user may perform. A similar login procedure may be instituted at any of the other hardware pieces.

If the data acquisition device 200 is a computer 202 or PDA 204, then data entry may be performed with a stylus and may further be performed via calculator-pad-style selection keys, pick lists, option buttons, and similar structures that display potential values to the user. Potential values may be loaded from a database. If the data acquisition device 200 is a specialty measuring equipment 206, the device buttons and sensor are the data entry tools. The data acquisition device 200 may preserve the data until it is successfully synchronized with a secure database. The desktop/desktop application 300 retains the information for the database. An acquisition application interfaces with the handheld instruments 200. The user may use a computer 202, a PDA 204, a specialty measuring device 206, or any combination thereof

The data acquisition equipment may do any one or more of the following.
Present and record values of the correct type for each datum
Allow for correction of erroneous values
Flag out-of-range values using business rules that describe the acceptable values for each datum
Flag transferred data
Allow for deletion of transferred data
Run on a Pocket PC, Tablet PC, or Palm device
Provide for survival of the data and application state in the event of the following error conditions:
   Untimely ejection of the memory card
   Battery failure on the acquisition device (especially during synchronization)
   Power failure on the part of the synchronization partner
   Failure of serial communications lines
   Operating system failure on the acquisition device
   Operating system failure on the synchronization partner
   Operator error such as:
      Assigning incorrect identifying values to the data set (ship, TOI number, etc.)
      Synchronizing the wrong data set
      Accidentally unplugging a communications cable
      Terminating the application using the stylus at an inopportune time
      Failing to activate the synchronization manager before attempting synchronization
      Canceling the synchronization process
      Providing incorrect OS or application settings to either synchronization partner
      Log user actions so that data may be reconstructed, as necessary

As discussed, multiple types of data acquisition devices 200 may be used. These devices 202, 204, 206 may synchronize data to a central database 400 in a variety of ways. Some devices may manage synchronization through embedded firmware. For these devices, data will be acquired through at least two separate data streams. These streams need to be combined and the data aggregated during synchronization. The data acquisition devices 200 may synchronize through a variety of hardware conduits. Such hardware conduits may comprise, for example, serial connections, such as a multi-pin serial connection, USB connection, IEEE 1394 interface, or a combination thereof. Such connections may incorporate standard or proprietary connectors, or both. Further, synchronization may occur through an infrared serial port or parallel port. Synchronization may be initiated by either synchronization partner. Synchronization may also be capable of cancellation from either synchronization partner. The synchronization conduit may:
Transfer data via serial communications
Guarantee the integrity of the data both during and after transfer
Mark transferred data as transferred at the data acquisition device 200
Make the data available to a data aggregation manager at the synchronization partner
Preserve the state of both the application and the data during errors like the following:
   Untimely ejection of the memory card
   Battery failure on the acquisition device (especially during synchronization)
   Power failure of the synchronization partner
   Failure of serial communications lines
   Operating system failure on the acquisition device
   Operating system failure on the synchronization partner
      Preserve both the state of the application and the data if the user cancels synchronization
      Run on a Pocket PC, Tablet PC, Palm device, or client computer
      Log activity at both partners so that data may be reconstructed, as necessary

Because data may arrive from multiple serial streams, an aggregation element 300 may reconcile the streams and insert the data into a database. The character of the streams is markedly different. Data arriving from a PDA or Tablet or Pocket PC 200 may be under programmatic control and may be properly formatted for insertion into the database when it arrives. Data 200a arriving from an instrument may arrive from proprietary, embedded software 2100 2200, and the aggregation element 300 may parse the data stream and correctly format the data for insertion into the database.

There are four realistic aggregation scenarios: 1) Instruments and PDAs synchronize with a desktop PC that manages aggregation; 2) Instruments synchronize to a PDA, which then synchronizes with a desktop PC that manages aggregation; 3) Instruments and PDAs synchronize to a tablet PC that joins the network and manages aggregation; 4) Instruments, PDAs, and Tablet PCs synchronize to a desktop PC that manages aggregation. The aggregation manager may run on Pocket PCs, PDA devices, Tablet PCs, and desktop or laptop client computers. It may:
Receive the data from the serial data streams
Mark unidentified data with the correct ship, inspection, TGI number, and other identifiers
Insert the data into the database (or store data in a temporary format)
Protect the state of the application and the data in the event of:
   Failure of synchronization because of:
      User cancellation
      Failure of serial communications related to:
         Untimely ejection of a memory card
         Untimely unplugging of a cable
         Failure of either of the synchronization partners' OS
   Failure of the database connection
   Loss of network communications
   Traffic load on the network
   Database connection overload
   Database request overload
Log all data transactions so that they might be repeated manually, if necessary

The database 4000 may be stored under an Oracle or SQL Server. Standard tools provided by these vendors may manage the databases. All data manipulation may take place through explicitly defined transactions in stored procedures. Procedures may provide return codes that define the success or failure of the intended action. Procedures may have names descriptive of the action performed. If procedures are tied to a particular form or web page, an abbreviation of that form or page name may appear as a part of the procedure name.

The database 1100 may be structured according to the Entity-Relationship diagram of FIG. 13. A web-based user interface may be provided to:
Allow managers to modify incorrect data
Allow managers to identify, update, and delete coherent sets of data
Allow managers to update lists of standard items

Ideally, the database will reside on a central server. However, the data may also be maintained as a copy in a database located on the data-recording-side of the web-based database. Synchronization of data to the central web-based database may be performed at specified intervals. Acceptable delay increments may be pre-selected. All database connections may be managed by ADO.Net objects.

A central report manager running on a web server may provide reports to interested parties. Reports may be written in and managed by Crystal Reports. Data for reports may be structured and formatted by a stored procedure. The Crystal Reports template may format and display the data. Preferably, reports may run from a central web server. However, reports may also need to run from a local database at the clients' site. Various reports may be provided, such as a Task Group Instruction (TGI) or a Naval Sea Systems Command (NAVSEA) Standard Item Requirements.

The contents of the TGI report are determined by the type of structure being treated for preservation at sea. Such structures may include Ballast tanks, Torpedo Ejection Pump/Torpedo Tube Recess, Aft Free Flood tanks (Mud Tanks), Retractable Bow Plane Recess, bilge sumps, bilge collection tanks, waste oil collection tanks, sanitary tanks, Bow tanks, Trim tanks, Water Round Torpedo tanks, auxiliary tanks, Impulse tanks, sea water expansion tanks, Vertical Launch System bath tub recess, Fairwater interior, Potable water tanks, and Reserve Feed Tanks.

NAVSEA standards provide instruction for assessing the cleaning, surface preparation, and painting processes. NAVSEA Standards are updated on by the Navy on an annual basis. Therefore, the software may preferably have version tracking capabilities. This will assure that the proper requirements are used for new measurements.

The types of forms required by 009-32 prescribed work are listed below.

a. Environmental Readings

b. Surface Soluble Salt Conductivity Log

c. Surface Profile Log

d. Dry Film Thickness Measurements

e. Checkpoints and Milestones Completion Log.

f. Certified Coating Inspector's Checkpoint Sign-Off Log

g. Paint Application Equipment and Paint Consumption Log

h. Wet Film Thickness Measurements

I. Test for Assessment of Surface Cleanliness—Pressure-Sensitive-Tape Method

j. Test for Assessment of Surface Cleanliness

Accordingly, the tool kit 100 may measure these conditions.

The tool kit 100 may track ambient and metal surface temperatures, relative humidity, and dew point at pre-determined intervals during the preservation process. These may be recorded from conditions onsite, in close proximity to the structure being coated. Coatings can only be applied when the temperature of the prepared substrate is within a certain range, such as greater than 50° F. and a minimum of 5° F. above the dew point (x<dew point+5<50).

Prior to coating or other treatment, a surface must be properly prepared. Such preparation may include blasting or water jetting operations. After such operations, surface peak-to-valley profile may be checked. Five profile readings may be taken for the first 1,000 ft², and 2 profile readings taken for each additional 1,000 ft². Each group of profile readings must average 0.002 to 0.004 inches, with no reading less than 0.001 inches or more than 0.005 inches. The automation of this module should include a user prompt, “Estimate area (ft²) Involved.” An algorithm may also compute the number of readings required based on the requirements stated above.

Readings may be associated with several external factors, such as, for example, Paint information, Temperature, Manufacturer, Formula, and Type, Batch No., and Receipt Inspection Record Number, and may be input through the use of pull-down menus.

Using the Bresle Method or an approved equivalent, 5 measurements may be made for every 1,000 ft². Therefore, information derived from “Estimate Area (ft²) Involved,” required for Surface Profile readings must be applied here, as well. Areas less than 1,000 ft² will have 5 measurements taken. Conductivity measurements must not exceed 30 microsiemens/cm² for critical-coated areas, or 50 microsiemens/cm² for non-critical coated areas.

Using specialized measuring equipment, such as Elcometer's 456 Dry Film Thickness (DFT) Gauge, the DFT of each coat applied may be measured. Each coat and type of material used will have a specified minimum and maximum DFT values.

Wet Film Thickness (WFT) readings may be obtained in lieu of DFT readings for any coat that must be in a tacky state when the next coat is applied.

This module may be used for any deficiencies that do not require Engineering Department resolution. However, any and all deficiencies that are found must be cleared before proceeding to the next coat; any item entered in this area also requires reinspection by a QA inspector.

Preservation Minor Deficiencies houses the required information. “Deficiency Found Sign and Date” requires the date stamp generated by the user's CAC-card insertion and digital signature. The “Location and Description of Deficiency” field, initially, will require a description field where the user may type in the applicable information. Once the system is in place at any given location, however, the “location” field can be customized to better meet the users' needs with an acceptable pull-down menu. The “description” portion of this particular column can be filled with a pull-down menu which lists the most common deficiencies and a continued descriptive (typing) field for deficiencies not yet included in the pull down.

A Sound Damping Deficiencies module may be used to record any deficiencies noted in the sound damping/acoustic tile inspection required after sand blasting operations.

At various times throughout the preservation process, checkpoints fail, rework is accomplished and a new inspection may be accomplished. All previous inspection results for the failed inspection must remain in the system and the new results posted. A re-inspect module may be used to track these inspections.

Deficiencies noted during inspections may be handled in many different ways depending on the activity and the type of deficiency (whether it is minor or major). There are many effective deficiency tracking systems in use and this system may support interface with those systems and also provide a stand alone capability. (i.e., if the activity has a functioning electronic deficiency tracking system this system should be able to capture the deficiency and note it has been entered in and is being tracked on the in house system. In addition, this system may be capable of providing the deficiency information to decision makers via an alternate path if desired by the end user. If no electronic system exists, this system may provide that capability.

Readings taken during preservation in-process inspections are required to fall within certain limits. These limits are established by NAVSEA, SSPC, NACE and paint manufacturers for their products. The data includes coating thickness, environmental conditions, surface roughness measurements, soluble salts readings, etc. out-of-tolerance conditions recorded need to be annotated in some fashion (i.e., color-coded red is one possibility) to notify supervisors of the condition. The initial reading must be tracked and retained as part of the permanent record even after the condition has been adequately adjudicated (i.e., color change to yellow). Requirements vary by product, manufacturer, end use, etc. These requirements change as products change, and test results indicate new limits are warranted.

A variety of management reports may be required by both in-house and external organizations. These reports may need to be automatically generated under certain pre-specified conditions and time intervals. Additional reports may be generated as called for by authorized users. Various metrics may be required and data trend analysis conducted.

Navy and private facilities doing preservation work are located all over the world. The majority of the data transfer and reporting services for this project will be conducted via the internets. The latest inspection data needs to be available 24 hours a day, 7 days a week to inspectors doing in-process inspections. Reports may be generated and posted as rapidly as the incoming data will allow. For instance, managers in Hawaii may need access to work conducted over the weekend on their ships in West Coast shipyards. The preservation process data is both business sensitive and Navy sensitive. The web services must be secure and password protected, allowing only specified end users access. The data and reports must also be segregated to allow specific users access only to the various data sets under their purview.

The tool kit 100 database function architecture is shown in FIG. 4. The architecture comprises the quality assurance (QA) central tool kit database 4000. The functions preferably required of the architecture include managing QA data 4100, generating standard reports 4200, answering ad hoc query and report requests 4300, generating and displaying job status and trending charts 4400, and supporting system administration 4500. FIG. 5 shows each function in more detail.

Referring now to FIGS. 6-12, a flowchart example of the tool kit functions will now be discussed. Data acquisition device function scenario 11000, QA toolkit inspector client scenario 12000, a web service scenario 13000, a ship setup scenario, a creation of new user scenario 15000, a adjudication procedure scenario 1600, and a creation of documentation scenario 17000 are provided.

Referring to FIG. 7, various measurement collection functions 11002-11012 of the data acquisition device are laid out. These measurements are collected by a user of the system. These measurements are aggregated by the QA toolkit inspector client 12000 at the aggregation work station. The user logs into the workstation to upload the data from the data acquisition tool. If the user is not in the system, then they will need to be added to the system. FIG. 10 provides a scenario for creating a new user. These measurements are then associated with the appropriate job order and uploaded to the database. The process is repeated for multiple measurements. Once this process is completed, appropriate documentation may be created.

Referring now to FIG. 8, a web service scenario 13000 is provided. As information is uploaded to the database, the measurements are compared to the various acceptable data values 13006. It is then determined whether or not the measurements are within spec. If they are within spec, the data is uploaded to the database. If the measurements are out of spec, then an adjudication process is initiated (see FIG. 11).

Referring now to FIG. 9, a TGI creation and ship setup scenario 14002-14038 is provided. When a ship building process is initiated, appropriate information about it needs to be entered into the QA tool kit. If the ship is in the system, then a TGI (job order) may be created. The TGI is created by selecting the appropriate ship, the surface(s) to be treated and the appropriate coating materials. If the ship is not in the system, then the ship, compartment and coating may need to be entered in the system before selection.

Referring now to FIG. 11, an adjudication scenario is provided. If a measure is determined to be out of spec in step 13014, then an adjudication process is initiated. A contractor is notified of the defect and initiations a plan to correct the defect, a higher authority is notified of this plan and negotiations may be needed to come to an acceptable plan. Once this is reached, the defect may be corrected.

Referring now to FIG. 12, a documentation scenario is provided. A request for documentation is provided from step 12034. whether or not the measurements are in or out of spec, an appropriate report may be generated.

1. A method of quality assurance, comprising the steps of:
providing a data acquisition device;
providing a data aggregator;
providing a database server for a central database; and
providing a report generator;
said data acquisition device prompts a user for identification credentials;
synchronizing data from said data acquisition device to said data aggregator;
aggregating data collected by said data acquisition device at said data aggregator;
storing said aggregated data at said database server and central database;
generating a report at said report generator;
wherein said report generator and said database server are connected via an internet;
wherein said data acquisition device is adapted to collect and store a plurality of quality characteristics of a painted surface.

2. The method of claim 1, wherein said plurality of quality characteristics may comprise one or more of the following: date, time, ambient temperature, lowest substrate temperature, dew point, humidity, abrasive blasting, preservation, anti-fouling, conductivity, dry film thickness, wet film thickness, preservation minor deficiencies, and sound damping deficiencies.

3. The method of claim 1, further providing a plurality of clearance levels.

4. The method of claim 3, wherein a first of said plurality of clearance levels is capable of reading and writing to all of said plurality of quality characteristics; and
wherein the rest of said plurality of clearance levels is capable of reading and writing to an amount that is less than all of said plurality of quality characteristics.

5. The method of claim 1, further providing synchronization of potential values for said plurality of quality characteristics from said database server to said data acquisition device.

6. A tool kit for quality assurance, comprising:
a data acquisition device;
a data aggregator;
a database server for a central database; and
a report generator;
said data acquisition device adapted to prompt a user for identification credentials;
said data acquisition device to said data aggregator are adapted to synchronize data between one another;
said data aggregator adapted to aggregate data collected by said data acquisition device;
said database server and central database adapted to store said aggregated data;
said report generator adapted to generate a report;
wherein said report generator and said database server are connected via an internet;
wherein said data acquisition device is adapted to collect and store a plurality of quality characteristics of a painted surface.

7. The tool kit of claim 1, wherein said plurality of quality characteristics may comprise one or more of the following: date, time, ambient temperature, lowest substrate temperature, dew point, humidity, abrasive blasting, preservation, anti-fouling, conductivity, dry film thickness, wet film thickness, preservation minor deficiencies, and sound damping deficiencies.

8. The tool kit of claim 1, further comprising a plurality of clearance levels.

9. The tool kit of claim 3, wherein a first of said plurality of clearance levels is capable of reading and writing to all of said plurality of quality characteristics; and
wherein the rest of said plurality of clearance levels is capable of reading and writing to an amount that is less than all of said plurality of quality characteristics.

10. The tool kit of claim 1, further comprising synchronization of potential values for said plurality of quality characteristics from said database server to said data acquisition device.
